(19) United States
(12) Patent Application Publication
(10) Pub. No.: US 2011/0159388 A1
(43) Pub. Date: Jun. 30, 2011

(54) Visualization Apparatus for PEMFC Stack

(75) Inventors: Joongmyeon Bae, Daejeon (KR); Dongryul Lee, Hwaseong-si (KR)

(73) Assignee: KOREA ADVANCED INSTITUTE OF SCIENCE AND TECHNOLOGY, Daejeon (KR)

(21) Appl. No.: 12/976,907

(22) Filed: Dec. 22, 2010

(30) Foreign Application Priority Data
Dec. 29, 2009 (KR) 10-2009-0132691

(51) Int. Cl. H01M 8/04

(52) U.S. Cl. 429/428

(57) ABSTRACT

Provided is a visualization apparatus for a PEMFC stack using a transparent window. More particularly, provided is a visualization apparatus for a PEMFC stack including: a plurality of visualization apparatuses for unit cells including current collector plates each provided on both sides of a membrane electrode assembly of a PEMFC and formed with channels through which reaction gas and products flow and a transparent plate provided on the outer surface of the current collector plate. Provided is a visualization apparatus for a PEMFC stack electrically connecting the current collector plates of the visualization apparatus for unit cells to each other in series.

### TECHNICAL FIELD

The present invention relates to a visualization apparatus for a PEMFC stack using a transparent window, and more particularly, to a visualization apparatus for a PEMFC stack capable of having conditions approximating a real PEMFC by implementing a single PEMFC stack by electrically connecting a plurality of visualization apparatuses for unit cells in series and connecting them to each other in parallel in distributing fuel.

### BACKGROUND ART

As environmental regulations of automobile markets are increasingly tightened, the world's carmakers have tried to develop environment-friendly and high-efficient cars. It is expected that the fuel-cell car will emerge as the center focus of an automobile market in the future because it is environmentally friendly in that it only discharges water while having high efficiency. As a result, many carmakers have continued to develop a fuel-cell car. A demand for a fuel-cell technology has continuously increased in the industrial world and the academic world. Therefore, research into a PEMFC for a car, for example, a proton exchange membrane fuel cell (PEMFC), has been actively conducted.

An operating temperature of a general PEMFC shown in FIG. 1 is less than 100° C. Therefore, water generated due to the reaction of hydrogen with oxygen is a liquid phase. When the liquid phase water is discharged while flowing in a PEMFC channel along with air, this is called a flooding phenomenon. The flooding phenomenon has been known as one of the main factors that degrade PEMFC performance. However, since it is difficult to visualize a two-phase flow in the PEMFC channel, research into the flooding has been mainly conducted through interpretation using a CFD.

In addition to the CFD, a method of observing the flooding by visualizing the two-phase flow in the PEMFC channel has been used. As an example, there is a method of observing the flooding in the PEMFC channel by using a neutron beam. Even though there is no need to change the components of the PEMFC in order to observe the behavior of water using the neutron beam, and reliability is at the highest, an apparatus generating the neutron beam is very expensive. In addition, it is difficult to specifically know how water is discharged since a method of processing the image data is complex and the interface of water with air is unclear. In addition, since the image using the neutron beam is consequently implemented in a two-dimensional plane, it is difficult to know whether or not water is present in an anode or a cathode state.

Therefore, researchers in and outside the country have mainly used a visualization method using a transparent window. The method can directly visualize the two-phase flow within the channel, such that it can specifically observe the shape where water flows. However, unlike the real PEMFC, since a visualization apparatus using the visualization method uses a current collector plate 600 in which a passage is formed on a metal plate having a thickness of about 1 mm as shown in FIG. 2, instead of using a separator 60 shown in FIG. 1, in order to perform visualization, it has a larger possibility of distorting the two-phase flow within a channel 610, as compared to the real PEMFC. Therefore, it is very important to secure the reliability by comparing an I-V characteristic curve between the real PEMFC and the visualization apparatus.

Generally, the visualization apparatus includes a transparent plate 700 provided on the outer side of the current collector plate 600 to visually observe the channel 610 of the current collector plate 600, as shown in FIG. 2.

In observing the PEMFC using the visualization apparatus, the real PEMFC forms a single stack in which the plurality of unit cells are stacked in order to increase the output. Generally, the visualization apparatus can visualize only the individual unit cells, but the visualization apparatus has not yet been developed to visualize the entire stack or the unit cells after being assembled into the stack.

### DISCLOSURE

### Technical Problem

An object of the present invention is to provide a visualization apparatus for a PEMFC stack capable of visually observing a flow phenomenon in a stack in which a plurality of unit cells are stacked.

### Technical Solution

In one general aspect, a visualization apparatus for a PEMFC stack includes: a plurality of visualization apparatuses for unit cells including current collector plates 600 each provided at both sides of a membrane electrode assembly 50 of a PEMFC and formed with channels 610 through which reaction gas and products flow and transparent plates 700 provided at the outer surfaces of the current collector plates 600, wherein it is configured by electrically connecting the current collector plates of the visualization apparatus for unit cells to each other in series.

Fuel distribution structures supplying reaction gas to the channels of the visualization apparatuses for each unit cell and discharging products from the channels may be connected to each other in parallel.

The visualization apparatus for a PEMFC stack may further include a unit cell monitoring unit measuring voltage of the visualization apparatuses for each unit cell.

### Advantageous Effects

According to the visualization apparatus for the PEMFC stack, it is possible to visualize the PEMFC approximating the car or the household power generation system used in the stack form in which the real unit cells are stacked.

The present invention can observe the change in visual flow and voltage for each unit cell in the stack, thereby making it possible to analyze the unit cell in the assembled state of the stack in the PEMFC.

### DESCRIPTION OF DRAWINGS

The above and other objects, features and advantages of the present invention will become apparent from the following description of preferred embodiments given in conjunction with the accompanying drawings, in which:

FIG. 1 is an exploded view of a real PEMFC;

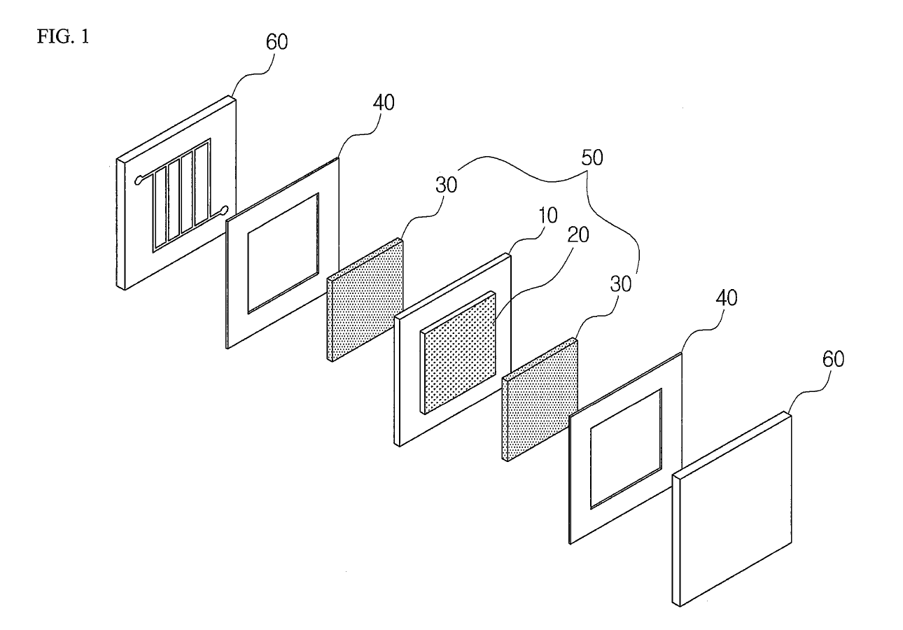

FIG. 2 shows a shape of a visualization apparatus for a unit cell;

FIG. 3 shows a shape of a PEMFC stack formed by stacking unit cells; and

FIG. 4 is a configuration diagram of a visualization apparatus for a PEMFC stack according to the present invention.

### DETAILED DESCRIPTION OF MAIN ELEMENTS

10: POLYMER ELECTROLYTE MEMBRANE
20: CATALYST LAYER
30: GAS DIFFUSION LAYER
40: GASKET
50: MEMBRANE ELECTRODE ASSEMBLY
60: SEPARATOR
600: CURRENT COLLECTOR PLATE
610: CHANNEL
700: TRANSPARENT PLATE
800: FUEL DISTRIBUTION STRUCTURE
900: PEMFC STACK VOLTAGE MEASURING UNIT
910: UNIT CELL MONITORING UNIT
1000: VISUALIZATION APPARATUS FOR UNIT CELL
2000: VISUALIZATION APPARATUS FOR PEMFC STACK

### BEST MODE

Hereinafter, a visualization apparatus for a PEMFC according to the present invention will be described in detail with reference to the accompanying drawings.

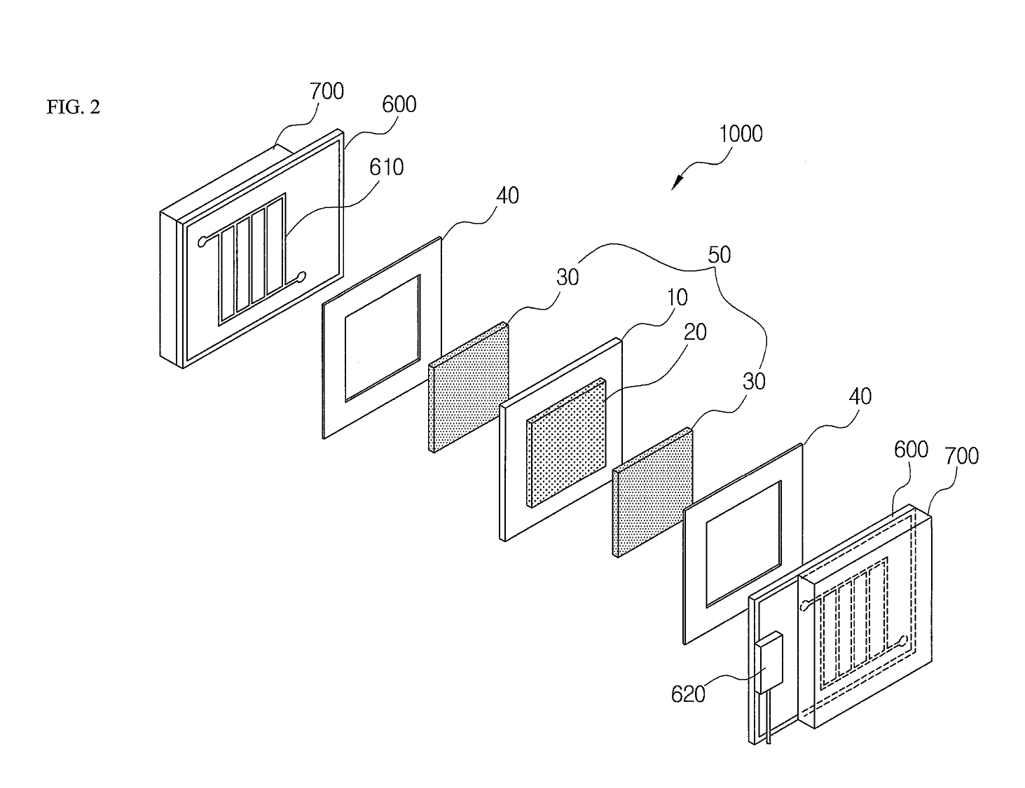

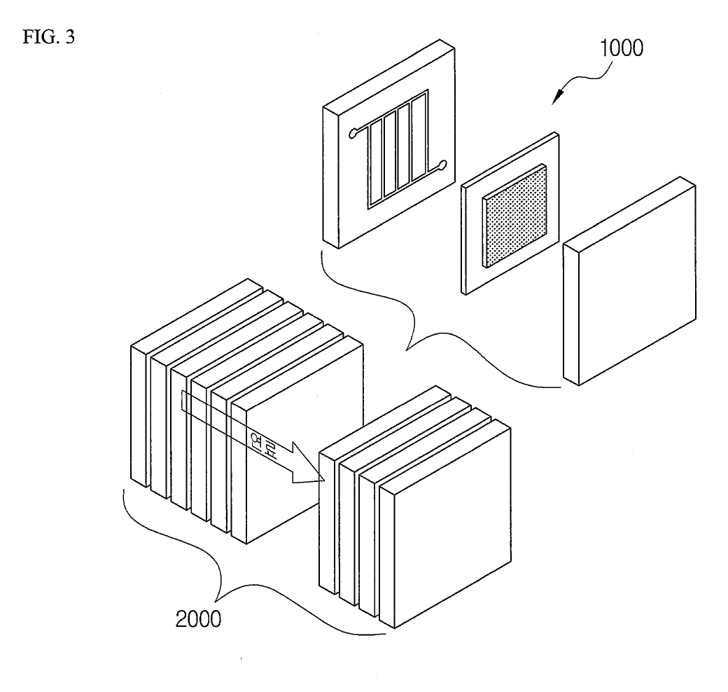

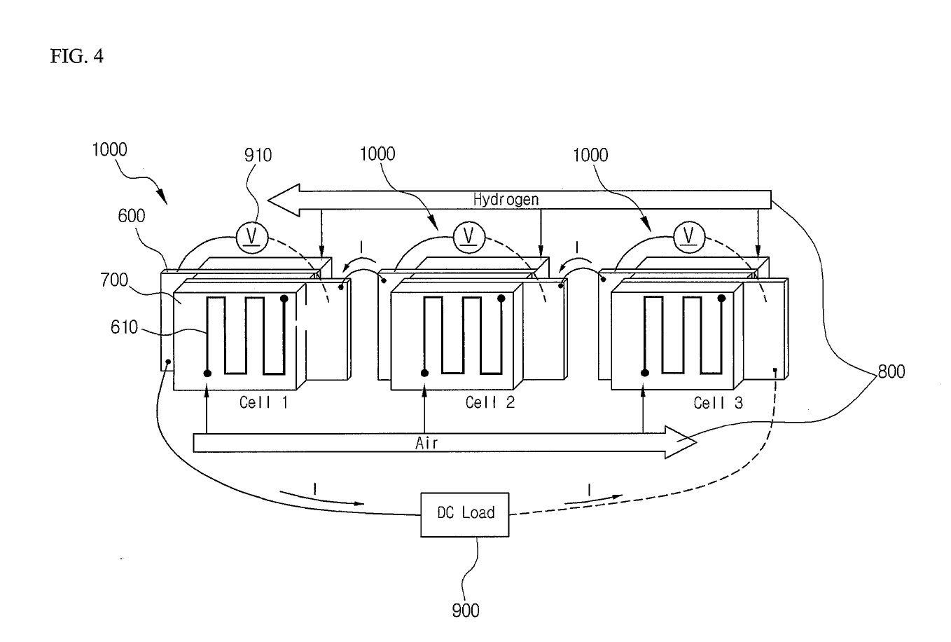

FIG. 2 is a shape of a visualization apparatus for a unit cell. FIG. 3 is a shape of a PEMFC stack in which unit cells are stacked and FIG. 4 is a configuration diagram of the visualization apparatus for a PEMFC stack according to the present invention.

As shown in FIG. 2, unlike a real PEMFC, a visualization apparatus 1000 for a unit cell includes current collector plates 600 formed with channels 610 through which reaction gas and products flow, instead of separators 60 provided at both sides of a membrane electrode assembly 50 of a PEMFC including a polymer electrolyte membrane 10, a catalyst layer 20, and gas diffusion layers 30, having a gasket 40 therebetween, and transparent plates 700 formed on the outer surface of the current collector plates 600.

The current collector plate 600 is composed of a metal plate having a thickness of about 1 mm and is provided with the channels 610 corresponding to a passage for reaction gas and products. The passage of the current collector plate 600 is visually observed through the visualization apparatus for a PEMFC.

The transparent plate 700 is configured to cover the outer surface of the current collector plate 600 and is made of a transparent material (polycarbonate, or the like) in order to observe a two-phase flow within the channel 610.

Since the real PEMFC uses the stack in which the plurality of unit cells are stacked in order to increase the output, there is a need to observe the stacked state, that is, the flow in the stack state, in addition to the case where the unit cell is operated individually. Considering this aspect, the present invention provides a visualization apparatus 2000 for a PEMFC stack of FIG. 4 as an apparatus for visualizing flow in a stack in which the unit cells are stacked as shown in FIG. 3.

Referring to FIG. 4, the visualization apparatus 2000 for a PEMFC stack according to the present invention is configured of the plurality of visualization apparatuses 1000 for unit cells. The visualization apparatuses 1000 for each unit cell are electrically connected to each other in series. More particularly, the anode current collector plates 600 of the visualization apparatuses 1000 for each unit cell are electrically connected with the cathode current collector plates 600 of the visualization apparatuses 1000 for other adjacent unit cells. Similarly, as the cathode current collector plates 600 of the visualization apparatuses 1000 for each unit cell are electrically connected with the anode current collector plates 600 of the visualization apparatuses 1000 for other adjacent cells, the visualization apparatuses 1000 for each unit cell are electrically connected to each other in series, which has the same current collection flow as the stack.

In this case, fuel distribution structures 800 of anode fuel and cathode fuel supplied to the channels 610 formed on each current collector plate 600 are connected to each other in parallel in order to implement the flow in the stack. As shown in FIG. 4, the anode and cathode channels 610 of the visualization apparatuses 1000 for each unit cell are individually supplied with fuel by the fuel distribution structures 800.

Since the visualization apparatus 2000 for a PEMFC stack according to the present invention is provided with the separate transparent plates 700 for each unit cell, it is possible to discriminate any change in flow in each cell and visually observe the change in flow, in consideration of the stacked state of the stack.

In addition, voltage generated from the entire PEMFC stack can be measured by a PEMFC stack voltage measuring unit 900 from the anode current collector plate 600 of the visualization apparatus 1000 for a unit cell disposed at one end thereof and the cathode current collector plate 600 of the visualization apparatus 1000 for a unit cell disposed at the other end thereof and the visualization apparatus for a unit cell includes a unit cell monitoring unit 910 measuring voltage of each unit cell by grounding the anode current collector plates 600 and the cathode current collector plates 600 for each unit cell to observe each unit cell.

The present invention is not limited to the embodiment described herein and it should be understood that the present invention may be modified and changed in various ways without departing from the spirit and the scope of the present invention. Therefore, it should be appreciated that the modifications and changes are included in the claims of the present invention.

1. A visualization apparatus 2000 for a PEMFC stack, comprising:
a plurality of visualization apparatuses 1000 for unit cells including current collector plates 600 each provided at both sides of a membrane electrode assembly 50 of a PEMFC and formed with channels 610 through which reaction gas and products flow and transparent plates 700 provided at the outer surfaces of the current collector plates 600,
wherein it is configured by electrically connecting the current collector plates of the visualization apparatus 1000 for unit cells to each other in series.

2. The visualization apparatus 2000 for a PEMFC stack of claim 1, wherein fuel distribution structures 800 supplying reaction gas to the channels 610 of the visualization apparatuses 1000 for each unit cell and discharging products from the channels 610 are connected to each other in parallel.

3. The visualization apparatus 2000 for a PEMFC stack of claim 1, further comprising a unit cell monitoring unit 910 measuring voltage of the visualization apparatuses 1000 for each unit cell.
